(19) United States
(12) Patent Application Publication
(10) Pub. No.: US 2017/0022905 A1
(43) Pub. Date: Jan. 26, 2017

(54) Low pressure compressor diffuser and cooling flow bleed for an industrial gas turbine engine

(71) Applicants: John A. Orosa, Palm Beach Gardens, FL (US); Joseph D. Brostmeyer, Jupiter, FL (US); Justin T. Cejka, Palm Beach Gardens, FL (US); Russell B. Jones, North Palm Beach, FL (US)

(72) Inventors: John A. Orosa, Palm Beach Gardens, FL (US); Joseph D. Brostmeyer, Jupiter, FL (US); Justin T. Cejka, Palm Beach Gardens, FL (US); Russell B. Jones, North Palm Beach, FL (US)

(21) Appl. No.: 15/137,280

(22) Filed: Apr. 25, 2016

Related U.S. Application Data
(60) Provisional application No. 62/195,515, filed on Jul. 22, 2015.

(51) Int. Cl. F02C 9/18; F02C 7/18; F02C 3/04

(52) U.S. Cl. CPC F02C 9/18; F02C 3/04; F02C 7/18; F05D 2220/32

(57) ABSTRACT

An industrial gas turbine engine with a high spool and a low spool in which low pressure compressed air is supplied to the high pressure compressor, and where a portion of the low pressure compressed air is bled off for use as cooling air for hot parts in the high pressure turbine of the engine. Annular bleed off channels are located in the LPC diffuser. The bleed channels bleed off around 15% of the core flow and pass the bleed off air into a cooling flow channel that then flows into the cooling circuits in the turbine hot parts.

### CROSS-REFERENCE TO RELATED APPLICATIONS

This application claims the benefit to U.S. Provisional Application 62/195,515 filed on Jul. 22, 2015 and entitled LOW PRESSURE COMPRESSOR DIFFUSER AND COOLING FLOW BLEED FOR AN INDUSTRIAL GAS TURBINE ENGINE.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to an industrial gas turbine engine for electric power generation, and more specifically, to cooling air bleed off from a low pressure compressor (LPC) diffuser for use as cooling air in turbine hot parts.

Description of the Related Art including information disclosed under 37 CFR 1.97 and 1.98

An industrial gas turbine engine is used for electrical power production where the engine drives an electric generator. Compressed air from a compressor is burned with a fuel in a combustor to produce a hot gas stream that is passed through a turbine, where the turbine drives the compressor and the electric generator through the rotor shaft. In an industrial gas turbine for electric power production, the speed of the generator is the same as the rotor of the engine since the use of a speed reduction gear box decreases the efficiency of the engine. For a 60 Hertz system, the generator and engine speed is 3,600 rpm. For a 50 Hertz system like that used in Europe, the generator and the engine speed is 3,000 rpm.

Engine efficiency can be increased by passing a higher temperature hot gas stream through the turbine. However, the turbine inlet temperature is limited to material properties of the turbine parts exposed to the hot gas stream such as rotor blades and stator vanes especially in the first stage. For this reason, first stage airfoils are cooled using cooling air bled off from the compressor. Cooling air for the airfoils passes through elaborate cooling circuits within the airfoils, and is typically discharged out film cooling holes on surfaces where the highest gas stream temperature are found. This reduces the efficiency of the engine since the work done by the compressor on compressing the cooling air is lost when the spent cooling air is discharged directly into the turbine hot gas stream because no additional work is done on the turbine.

### BRIEF SUMMARY OF THE INVENTION

An industrial gas turbine engine for electrical power production, where the engine includes a high spool that drives an electric generator and a separate low spool that produces compressed air that is delivered to an inlet of the high pressure compressor (HPC) for turbocharging the high spool. A portion of the low pressure compressor (LPC) outflow or core flow is bled off and used as the cooling air for hot parts of the high pressure turbine (HPT). The cooling air flows through the hot parts for cooling, and is then discharged into the combustor and burned with fuel to produce the hot gas stream for the turbine. The work done on the compressed cooling air is thus not lost but used to produce work in the turbine.

The bleed off air for the cooling air is bled off from the LPC diffuser using first and second annular shaped bleed channels in series that flow into a cooling flow channel. Each bleed channel takes around 7.5% off the core flow for a total of around 15% of the core flow that is used for cooling air.

The annular shaped bleed channels are located on an inner surface of the LPC diffuser downstream from the LPC discharge. A throat followed by a diverging section is located after the bleed channels and upstream of the cooling flow channel.

### BRIEF DESCRIPTION OF THE SEVERAL VIEWS OF THE DRAWINGS

FIG. 1 shows a cross sectional view of a LPC with a cooling air bleed off channels according to the present invention.

FIG. 2 shows a turbocharged industrial gas turbine engine with turbine hot part cooling of the present invention.

### DETAILED DESCRIPTION OF THE INVENTION

The present invention is an industrial gas turbine (IGT) engine for electrical power production where cooling air used for cooling of hot parts in the turbine (such as rotor blades or stator vanes or rotor disks) is bled off from a flow path surface of the LPC diffuser. The cooling air is passed through turbine hot parts (such as stator vanes, rotor blades, rotor disks, combustor liners) to be cooled, and then reintroduced into the compressed air from the high pressure compressor upstream of the combustor. The cooling air bled off from the LPC passes through a boost compressor to increase its pressure prior to passing through the hot parts to be cooled so that enough pressure remains after cooling of the hot parts to be discharged into the combustor along with compressed air from the main compressor.

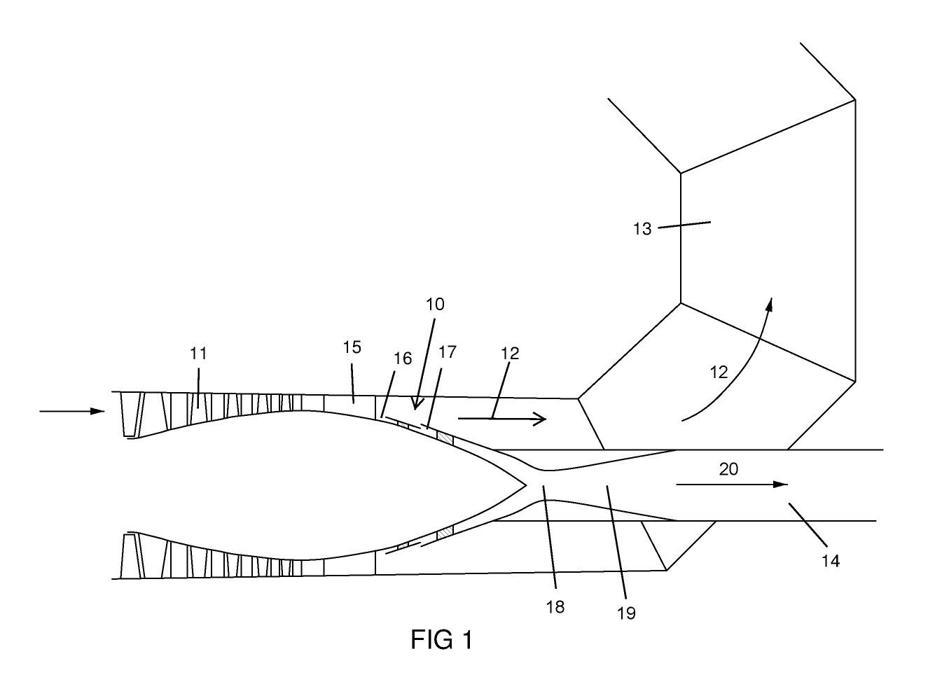

FIG. 1 shows the low pressure compressor (LPC) 11 of the IGT engine with multiple rows or stages of rotor blades and stator vanes followed by a LPC diffuser 10 and a cooling flow diffuser 19. Compressed air from the compressor exit flows along an inner surface where first and second bleeds 16 and 17 are located that bleeds off compressed air from the core flow 12. A strut 15 is located aft of the LPC 11 and near the inlet of the LPC diffuser 10. In this embodiment of the present invention, the two bleeds 16 and 17 each remove around 7.5% of the core flow for a total bleed off of 15% that then flows into the cooling flow channel 14. The core flow 12 flows through a duct 13 and into the inlet of the high pressure compressor (HPC) of the engine. The cooling flow 20 flows to hot parts of the engine such as the first stage stator vanes and even the first stage rotor blades to provide cooling for these hot turbine parts.

The cooling flow bleeds 16 and 17 enable a higher diffusion rate in the LPC diffuser 10 by restarting the boundary layer on the LPC diffuser 10 inner diameter (ID) flow path. The LPC diffuser 10 OD flow path loading is mitigated with zero slope flow path and OD strong LPC exit velocity profile. Cooling flow 20 diffusion in the cooling flow diffuser 19 can be delayed to minimize blockage by the cooling flow channel 14 inside the LPC-to-HPC duct. The bleed off compressed air from the bleeds 16 and 17 flows into a throat 18 and then through a cooling flow diffuser 19 before entering the cooling flow channel 14.

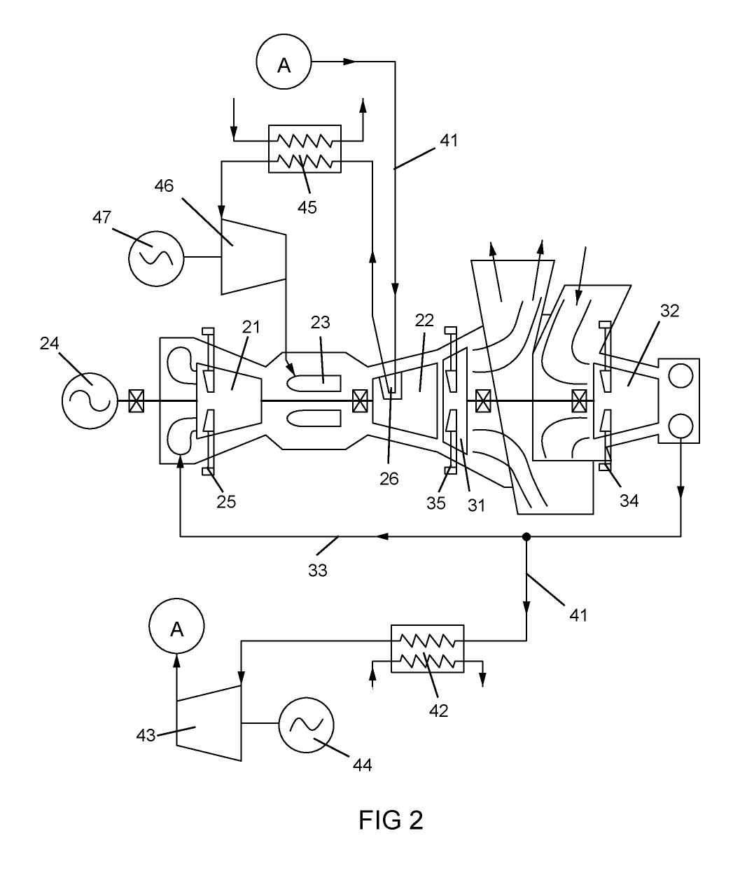

FIG. 2 shows an industrial gas turbine engine with cooling air for a turbine hot part that is discharged into the combustor instead of the turbine hot gas stream. FIG. 2 shows one embodiment of a turbocharged IGT engine of the present invention with a high spool or main spool having a high pressure compressor 21, a high pressure turbine 22 that drives the HPC 21, and a combustor 23 to produce a hot gas stream that drives the HPT 22. The high spool drives an electric generator 24 to produce electrical power. A low spool or turbocharger is positioned adjacent to the high spool and includes a low pressure turbine 31 that drives a low pressure compressor 32 using turbine exhaust from the HPT 22. Variable inlet guide vanes 25 are used in the HPC 21, 34 in the LPC 32, and 35 in the LPT 31 to allow for the engine to produce twice the power of the prior art engine and in which the high pressure spool and a low pressure spool can be operated independently so that a turn-down ratio of as little as 12% can be achieved while still maintaining high efficiencies for the engine. A compressed air bypass line 33 connects the LPC 32 to the HPC 21 so that low pressure compressed air is supplied to the HPC 21.

In the FIG. 2 embodiment, cooling air for the turbine hot part is bled off from the compressed air bypass line 33 into a cooling air line 41 and passed through an intercooler 42 to cool the low pressure compressed air. This low pressure cooling air is then increased in pressure by a boost compressor 43 driven by a motor 44 with enough pressure to pass through an internal cooling circuit of the turbine hot part, which in this case is a stage or row of turbine stator vanes 26. The spent cooling air from the vanes 26 is then passed through a second intercooler 45 and then compressed by a second boost compressor 46 driven by a second motor 47 with enough pressure to be discharged into the combustor 23 and merged with compressed air from the HPC 21. In FIG. 1, the duct 13 is the compressed air bypass line 33 in FIG. 2 and the cooling flow channel 14 in FIG. 1 is the cooling air line 41 in FIG. 2.

Spent cooling air from the turbine hot parts is reintroduced into the combustor 23 through a diffuser located downstream from the high pressure compressor, where spent cooling air from the stator vanes is discharged along an outer surface of the HPC diffuser in a direction parallel to the main flow, and cooling air from the rotor blades is discharged along an inner surface of the HPC diffuser in a direction parallel to the main flow. The spent cooling air flows toward the HPC diffuser and then turns about 180 degrees to flow parallel and in the same direction of the main flow from the compressor through the diffuser. With this design, the spent cooling air flows at a higher velocity within the HPC diffuser than the main compressed air flow from the HPC to energize the boundary layer.

I claim the following:

1. An industrial gas turbine engine for electrical power production comprising:
a high spool with a high pressure compressor and a high pressure turbine;
a low spool with a low pressure compressor (LPC) and a low pressure turbine;
a compressed air duct connecting a core flow of the LPC to an inlet of the high pressure compressor;
a LPC diffuser air bleed channel to bleed off a portion of the core flow; and,
a cooling flow channel connected to the LPC diffuser air bleed channel.

2. The industrial gas turbine engine of claim 1, and further comprising:
the LPC diffuser air bleed channel bleeds off around 7.5% of the core flow of the LPC diffuser.

3. The industrial gas turbine engine of claim 1, and further comprising:
a second LPC diffuser air bleed channel located downstream from the first LPC diffuser air bleed channel to bleed off a second portion of the core flow; and,
the second LPC diffuser air bleed channel is connected to the cooling flow channel.

4. The industrial gas turbine engine of claim 3, and further comprising:
the first and second LPC diffuser air bleed channels bleed off around 15% of the core flow of the LPC diffuser.

5. The industrial gas turbine engine of claim 1, and further comprising:
the LPC diffuser air bleed channel is an annular shaped channel.

6. The industrial gas turbine engine of claim 3, and further comprising:
the first and second LPC diffuser air bleed channels are both annular in shape; and,
compressed air from the first bleed channel flows into the second bleed channel.

7. The industrial gas turbine engine of claim 1, and further comprising:
the LPC diffuser air bleed channel is an annular shaped channel on an inner surface of the LPC diffuser that forms the core flow of the LPC.

8. The industrial gas turbine engine of claim 1, and further comprising:
the LPC diffuser air bleed channel is an annular shaped channel; and,
a throat followed by a diverging section is located between the annular bleed channel and the cooling flow channel.

9. The industrial gas turbine engine of claim 3, and further comprising:
a third LPC diffuser air bleed channel located on an outer surface of the LPC diffuser to bleed off a third portion of the core flow; and,
the third low pressure compressed air bleed channel is connected to the cooling flow channel.
